(19) United States
(12) Patent Application Publication
(10) Pub. No.: US 2025/0236188 A1
(43) Pub. Date: Jul. 24, 2025

(54) SOCKET-TYPE CHARGING DEVICE

(71) Applicant: DELTA ELECTRONICS, INC., Taoyuan City (TW)

(72) Inventor: Weite HUANG, Taoyuan City (TW)

(21) Appl. No.: 19/013,770

(22) Filed: Jan. 8, 2025

Related U.S. Application Data
(60) Provisional application No. 63/624,549, filed on Jan. 24, 2024.

(30) Foreign Application Priority Data
Sep. 4, 2024 (CN) 202422164128.3

(51) Int. Cl. B60L 53/16; B60L 53/18; H02J 7/00

(52) U.S. Cl. CPC B60L 53/16; B60L 53/18; H02J 7/0047

(57) ABSTRACT

A socket-type charging device is disposed in an accommodation space of a socket box, and the socket box is embedded in a wall. The socket-type charging device includes a power port, a connection port, a controller, and a reset switch. The power port is coupled to a power wire through the socket box. The connection port connects a charging cable of charging and discharging an electric vehicle. The controller confirms an operating mode of charging and discharging the electric vehicle by the socket-type charging device.

### CROSS-REFERENCE TO RELATED APPLICATION

This patent application claims the benefit of U.S. Provisional Patent Application No. 63/624,549, filed Jan. 24, 2024, which is incorporated by reference herein.

### BACKGROUND

### Technical Field

The present disclosure relates to a charging device, and more particularly to a socket-type charging device applied to an electric vehicle.

### Description of Related Art

The statements in this section merely provide background information related to the present disclosure and do not necessarily constitute prior art.

Please refer to FIG. 1, which shows a schematic diagram of the appearance and structure of a conventional charging device 100A in traditional mode 3 is shown. The traditional charging device 100A is generally configured on the wall W, and the charging equipment is fixed on the wall W through an external plug-in manner. Therefore, the electric vehicle can be coupled by plugging to the charging cable, and the electric vehicle can then be charged. However, this fixed charging device 100A usually has problems such as accidental falling of the box, space occupancy, difficulty in installation, extrusion from foreign objects (such as but not limited to car bodies, debris, etc.), exposure to sunlight, and overweight. Moreover, the current output ports of the fixed charging device 100A connected to the charging cable generally only have a specific AC output port (according to the design of each car manufacturer) and a USB output port. However, the compatibility between various brands is low, and the solution is to use adapters or directly replace the brands of fixed charging equipment.

In addition, since the external charging device 100A may generally be installed outdoors, it must be exposed to wind, sun, and rain, and therefore it must be as waterproof and dustproof as possible. Moreover, in order to avoid damage to the internal circuit caused by impact after the charging device 100A is dropped, its shock resistance and drop resistance level must also be improved. Therefore, in order to increase the protection specifications, the charging device 100A is bulky and the design cost is high.

Therefore, how to design a socket-type charging device to prevent the charging device from falling off due to external forces such as collision and pulling, thereby avoiding the risk of falling off and hitting the ground and causing it to break has become a critical topic in this field.

### SUMMARY

In order to solve the above-mentioned problems, the present disclosure provides a socket-type charging device. The socket-type charging device is disposed in an accommodation space of a socket box, and the socket box is embedded in a wall. The socket-type charging device incudes a power port, a connection port, and a controller. The power port is coupled to a power wire through the socket box. The connection port is disposed on a side of the wall where the socket-type charging device is exposed, and the connection port connects a charging cable of charging and discharging an electric vehicle. The controller is coupled to the power port and the connection port, and the controller confirms an operating mode of charging and discharging the electric vehicle by the socket-type charging device.

The main purpose and effect of the present disclosure is that the socket-type charging device may be buried in the wall so that the socket-type charging device does not protrude from the wall. Therefore, in addition to enhancing the aesthetic appeal of the wall, it also prevents the socket-type charging device from falling off due to external forces such as collision and pulling, thereby avoiding the risk of falling off and hitting the ground and causing damage.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic diagram of the appearance and structure of a conventional charging device.

FIG. 2 is a structural assembly side view of a socket-type charging device according to a first embodiment of the present disclosure.

FIG. 3A is a front view of the socket-type charging device according to the first embodiment of the present disclosure.

FIG. 3B is a schematic diagram of configurable types of a connection port according to the present disclosure.

FIG. 4 is a block circuit diagram of the socket-type charging device according to the present disclosure.

FIG. 5A is a block circuit diagram of a proximity pilot circuit according to a first embodiment of the present disclosure.

FIG. 5B is a block circuit diagram of a proximity pilot circuit according to a second embodiment of the present disclosure.

FIG. 6 is a side view of the socket-type charging device according to a second embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

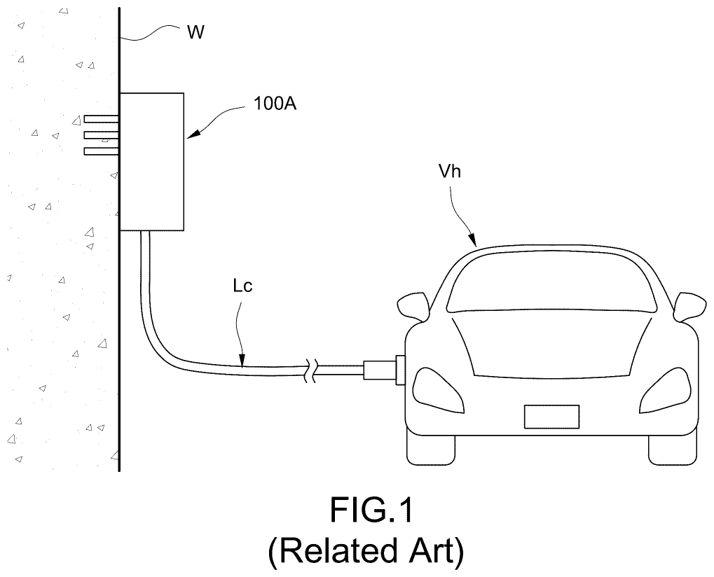

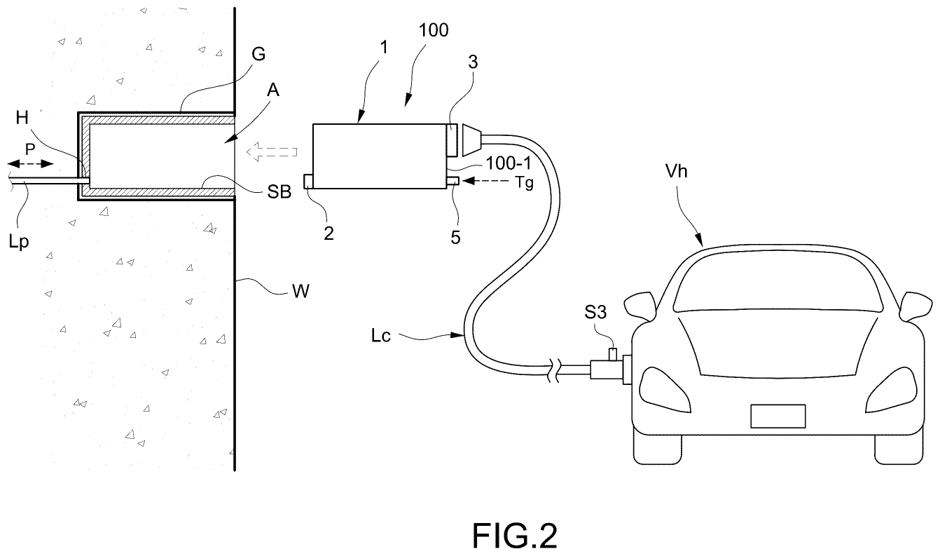

Please refer to FIG. 2, which shows a structural assembly side view of a socket-type charging device according to a first embodiment of the present disclosure, and also refer to FIG. 1. The difference between the socket-type charging device 100 of the present disclosure and the traditional charging device 100A shown in FIG. 1 is that the socket-type charging device 100 may be buried in the wall W so that the socket-type charging device 100 does not protrude from the wall W. Therefore, in addition to enhancing the aesthetic appeal of the wall W, it also prevents the socket-type charging device 100 from falling off due to external forces such as collision and pulling, thereby avoiding the risk of falling off and hitting the ground and causing damage. Furthermore, a socket box SB is used to be embedded in the groove G of the wall W, and the socket box SB includes a through hole H for the power wire Lp to pass through. The socket-type charging device 100 may be configured in an accommodation space A of the socket box SB, and the socket-type charging device 100 may be plugged into the power wire Lp and transmit power P (usually AC power, but not limited to this). In particular, the socket-type charging device 100 may be fixedly connected to the socket box SB by, for example but not limited to, locking, but is not limited to this.

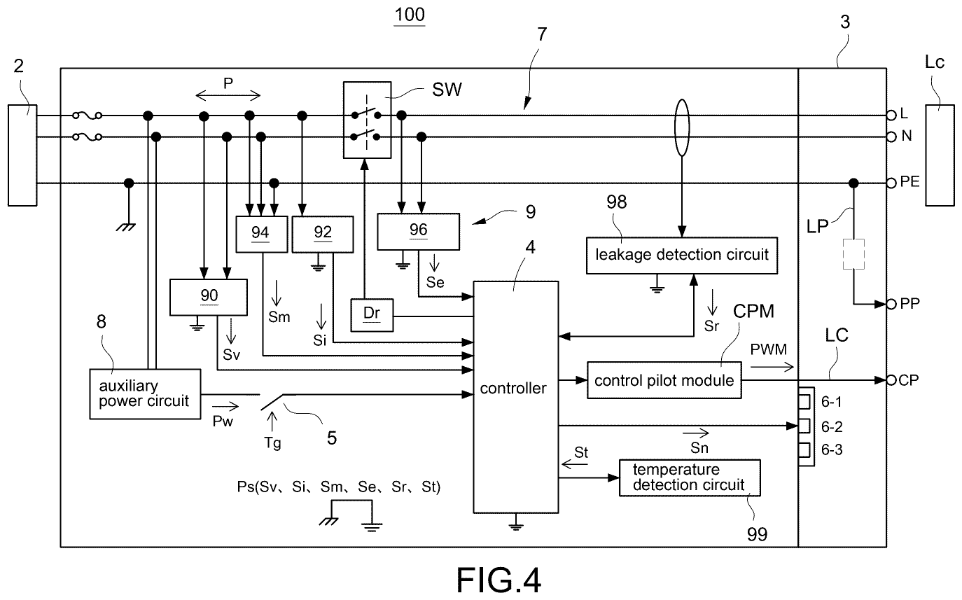

The fundamental configuration of the socket-type charging device 100 may include a housing 1, a power port 2, a connection port 3, a controller 4 (as shown in FIG. 4) and a reset switch 5. The housing 1 can be inserted into the socket box SB and accommodated in the accommodation space A. The power port 2 is preferably disposed on the housing 1, adjacent to a side of the accommodation space A, used for the power wire Lp to plug in to transmit the power P. The connection port 3 is disposed on a side 100-1 of the housing 1 exposed to the wall W, and is used for one terminal of a charging cable Lc to plug in, and the other terminal of the charging cable Lc plugs in an electric vehicle Vh, and therefore the power P is transmitted through the charging cable Lc. The controller 4 is disposed in the housing 1 and coupled to the power port 2 and the connection port 3. The controller 4 is mainly used to confirm the operating mode between the electric vehicle Vh and the socket-type charging device 100. For example, but not limited to, the charging mode of charging the electric vehicle Vh by the socket-type charging device 100, the discharging mode of discharging from the electric vehicle Vh to the socket-type charging device 100, or a standby mode that no power P is temporarily transmitted. Therefore, the socket-type charging device 100 is controlled to perform corresponding operations according to the confirmed operating mode.

Moreover, the controller 4 is mainly a controller with the function of locking the power output. Specifically, when the controller 4 determines that a specific situation occurs, it enters a locked state to avoid power transmission. The difference from the standby mode is that in the standby mode, once the socket-type charging device 100 reaches certain specific situations (for example, but not limited to, the communication between the socket-type charging device 100 and the electric vehicle Vh is completed, etc.), the controller 4 can control the transmission of the power P between the socket-type charging device 100 and the electric vehicle Vh. However, when the controller 4 enters the locked state, the controller 4 no longer controls the transmission of the power P between the socket-type charging device 100 and the electric vehicle Vh, unless the electric vehicle Vh is re-coupled by, for example but not limited to, re-plugging and unplugging the charging cable Lc, or by pressing a press switch S3 shown in FIG. 2, or resetting the supply of power P (for example, re-plugging the connection between power port 2 and power wire Lp, or resetting a circuit breaker at the source of power P) to release the locked state. In particular, the specific situation includes, but are not limited to, the socket-type charging device 100 detects overvoltage, overcurrent, communication signal abnormalities and other abnormal accidents, or improper wiring, but is not limited to this.

The reset switch 5 is disposed on the side 100-1 of the housing 1 exposed to the wall W (i.e., the reset switch 5 is disposed on the same side as the connection port 3), and is coupled to the controller 4. The reset switch 5 is mainly used to release the locked state of the controller 4 according to a trigger Tg when the controller 4 is in the locked state, instead of re-plugging the charging cable Lc or power port 2 to unlock. Moreover, after the controller 4 is released from the locked state, the controller 4 can reconfirm the operating mode and resume mutual communication with the electric vehicle Vh. Therefore, the reset switch 5 is used to release the locked state of the controller 4 so that the controller 4 can release certain specific conditions to return to the normal state without re-pressing the press switch S3 of the charging cable Lc or repeatedly plugging and unplugging the charging cable Lc. Therefore, the connector of the charging cable Lc can be prevented from being damaged or even ineffective due to repeatedly plugging and unplugging the charging cable Lc or excessively frequently pressing the press switch S3, or avoid the inconvenience of the user having to leave the socket-type charging device 100 to find the circuit breaker of the power source to reset the power supply. In one embodiment, the charging cable Lc having the press switch S3 is a unique feature of some charging cables Lc with specific specifications. However, the present disclosure does not take the example of being able to couple only the charging cable Lc with specific specifications. Therefore, all existing charging cables Lc with different specifications from various brands may be suitable for plugging into the socket-type charging device 100 of the present disclosure.

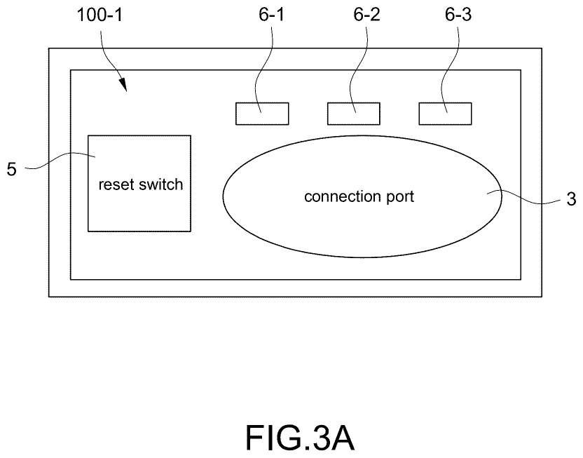

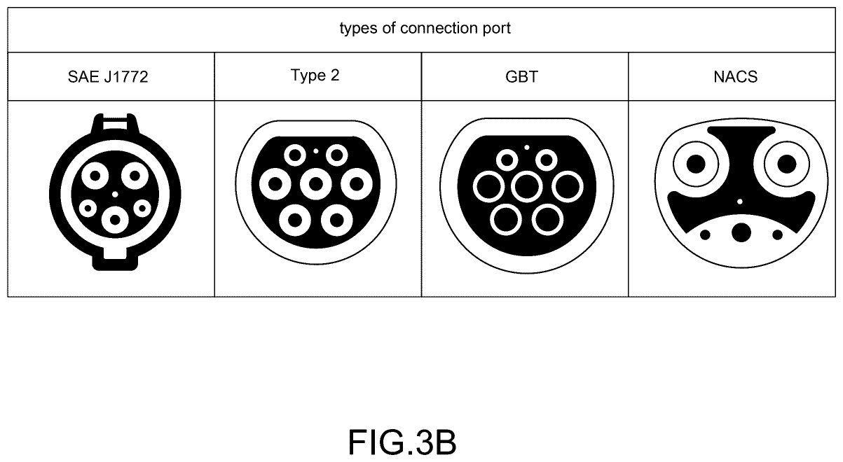

Please refer to FIG. 3A, which shows a front view of the socket-type charging device according to the first embodiment of the present disclosure, and also refer to FIG. 2. In FIG. 3A, the socket-type charging device 100 further includes indicator lights 6-1 to 6-3, and the connection port 3, the reset switch 5, and the indicator lights 6-1 to 6-3 are disposed on the side 100-1 of the housing 1 exposed to the wall W. Moreover, the connection port 3 shown in FIG. 3A may be configured with at least one of different types of connection ports as shown in FIG. 3B. Therefore, the connection port 3 may be SAE J1772, IEC 62196 type 2, or other various forms of connection ports 3. However, due to the many types, only the types with wider market shares are used as examples here, and are not limited to the types in FIG. 3B. The indicator lights 6-1 to 6-3 are coupled to the controller 4, and the controller 4 controls the indicator lights 6-1 to 6-3 to generate corresponding colored light according to the operating status. In particular, the number of indicator lights 6-1 to 6-3 is only for illustration, and they may be single or plural.

In one embodiment, three indicator lights 6-1 to 6-3 as shown in FIG. 3A, which may preferably include a standby indicator light 6-1 (for example but not limited to, a green light), a charging indicator light 6-2 (for example but not limited to, a yellow light), and a fault indicator light 6-3 (for example but not limited to, a red light). Therefore, when the controller 4 enters the locked state, the fault indicator light 6-3 can generate a corresponding colored light (i.e., a red-color light) so that the user intuitively realizes that the socket-type charging device 100 is locked and needs to press the reset switch 5 to release the locked state. In addition, when the number of the indicator lights 6-1 to 6-3 is one, any one of the indicator lights 6-1 to 6-3 may preferably be a light-emitting device that emits multi-color light. Therefore, the side 100-1 of the housing 1 exposed to the wall W may free up more space to configure other buttons, switches, and other devices. Moreover, the reset switch 5 mainly provides a function similar to the above-mentioned press switch S3, which is used to make the controller 4 reconfirm the operating mode when in the locked state, and re-communicate with the electric vehicle Vh to set parameters such as charging and discharging currents. In particular, the reset switch 5 may be a push-button type, a touch-type, a DIP-type (dual in-line package) switch, or any other switch with on-off functions, which is not limited here.

Please refer to FIG. 4, which shows a block circuit diagram of the socket-type charging device according to the present disclosure, and also refer to FIG. 2 to FIG. 3B. In FIG. 4, the socket-type charging device 100 further includes a power line 7, an auxiliary power circuit 8, a switch SW, and a detection module 9. A first terminal of the power line 7 is coupled to the power wire Lp through the power port 2, and a second terminal of the power line 7 is coupled to the charging cable Lc to transmit the power P. In particular, the power line 7 includes a live wire L, a neutral wire N, and a ground wire PE. In particular, the so-called “transmission” refers to the bidirectional flow of power P depending on whether the operating mode is the charging mode or the discharging mode.” The auxiliary power circuit 8 is coupled to the power line 7, and converts the power Pinto a working power Pw so as to provide the working power Pw to the controller 4 to supply power to the controller 4. In one embodiment, the reset switch 5 is coupled to the auxiliary power circuit 8 and the controller 4. Therefore, when the reset switch 5 is triggered by a trigger Tg, the reset switch 5 is turned off according to the trigger Tg so that a path between the auxiliary power circuit 8 and the controller 4 is disconnected and the working power Pw is cut off. Therefore, the controller 4 is unable to maintain operation due to insufficient energy, resulting in its entry into under-voltage protection (UVP) or even complete shutdown.

Afterward, after the reset switch 5 is turned off, the reset switch 5 can return to the conduction state again according to the trigger Tg, or actively return to the conduction state. Specifically, the user can turn off the reset switch 5 by pressing the reset switch 5, and when the controller 4 is unable to maintain operation due to insufficient energy to enter the under-voltage protection (UVP), the user can turn on the reset switch 5 by pressing the reset switch 5 again so that the controller 4 receives the working power Pw again to restart and return to the normal operation state. Alternatively, the reset switch 5 may be an active reset switch with a preset conduction state, and when the user presses the reset switch 5 and causes the reset switch 5 to be turned off according to the trigger Tg, the reset switch 5 can actively return to the conduction state after a short period of time so that the controller 4 can receive the working power Pw again to restart and return to the normal operation state. Finally, after the controller 4 is restarted to return to the normal operation state, the controller 4 can reconfirm the operating mode and resume mutual communication with the electric vehicle Vh.

The switch SW is disposed on the power line 7, and coupled to the controller 4, and therefore the controller 4 can short-circuit or disconnect the power line 7 by turning on and turning off the switch SW. The detection module 9 is coupled to the power line 7 and the controller 4, and is used to detect the power P of the power line 7 to generate a power parameter Ps. The controller 4 can selectively turn on and turn off the switch SW according to the power parameter Ps, and when the power parameter Ps is abnormal, the controller 4 turns off the switch SW to disconnects the power line 7 to avoid the transmission of the power P. Furthermore, when the controller 4 turns off the switch SW due to an abnormality in the power parameter Ps, the controller 4 determines that a specific situation occurs and enters the locked state. Please refer to FIG. 4 again, the detection module 9 includes a plurality of detection circuits, which may include, for example but not limitation, a voltage detection circuit 90, a current detection circuit 92, a ground detection circuit 94, a welding detection circuit 96, a leakage detection circuit 98, and a temperature detection circuit 99. The temperature detection circuit 99 is coupled to the controller 4, and the voltage detection circuit 90, the current detection circuit 92, the ground detection circuit 94, the welding detection circuit 96, and the leakage detection circuit 98 are coupled to the power line 7 and the controller 4.

The voltage detection circuit 90 detects a voltage between the power port 2 and the switch SW to generate a voltage signal Sv, and the controller 4 determines whether the voltage on the power line 7 is normal according to the voltage signal Sv. The current detection circuit 92 detects a current from the power port 2 to the switch SW to generate a current signal Si. The ground detection circuit 94 detects a ground impedance from the power port 2 to the switch SW to generate an impedance signal Sm so that the controller 4 can determine whether the grounding of the socket-type charging device 100 is normal according to the impedance signal Sm. The welding detection circuit 96 is coupled to the power line 7 between the switch SW and the charging cable Lc, and detects whether the switch SW is welded to generate a welding signal Se so that the controller 4 can determine whether the switch SW can be correctly turned off according to the welding signal Se. The leakage detection circuit 98 is coupled to the power line 7 between the switch SW and the charging cable Lc, and detects whether a leakage current occurs in the power line 7 to generate a leakage signal Sr so that the controller 4 determines whether the leakage current occurs in the power line 7 according to the leakage signal Sr. The temperature detection circuit 99 detects an ambient temperature in the housing 1 to provide a temperature signal St, and the controller 4 determines whether the ambient temperature in the housing 1 is too high according to the temperature signal St.

Therefore, the power parameter Ps may include the voltage signal Sv, the current signal Si, the impedance signal Sm, the welding signal Se, the leakage signal Sr, and the temperature signal St, and the controller 4 determines whether the switch SW is turned on or turned off according to the above-mentioned signals. Furthermore, the controller 4 can determine whether the power P on the power line 7 exists overvoltage (OV)/undervoltage (UV), overcurrent (OC), abnormal grounding, contact welding, and leakage current according to the voltage signal Sv, the current signal Si, the impedance signal Sm, the welding signal Se, and the leakage signal Sr. Moreover, the controller 4 can determine whether the ambient temperature in the housing 1 exists the over temperature (OT) according to the temperature signal St. When the above-mentioned abnormality does not occur, the controller 4 controls the switch SW to turn on after a handshaking communication is completed to supply power to the power line 7 to transmit the power P. On the contrary, in addition to the contact welding, the controller controls the switch SW to be turned off, thereby causing the power line 7 to be disconnected and unable to transmit the power P. Moreover, when the contact welding occurs, the switch SW cannot be turned off smoothly, and therefore the controller 4 can determine by itself that when the specific situation occurs, it enters the locked state to avoid being unable to turn off the switch SW and continue to transmit the power P. In particular, the switch SW may be a switch with two transistors connected in series or a switching component such as a relay that can be turned on and turned off in two directions. In addition, the switch SW can be driven to be turned on or turned off by, for example but not limited to, a driving circuit Dr. However, if the switch SW does not need to be driven by the driving circuit Dr, the driving circuit Dr may be omitted.

Moreover, since the socket-type charging device 100 of the present disclosure is arranged in the accommodation space A of the socket box SB, rather than inserted into the wall and protruding from the wall W, it is not susceptible to wind, sun, rain, etc. Therefore, the shock resistance level, sun protection level, and waterproof level of the socket-type charging device 100 can be greatly reduced. In contrast, since the above-mentioned levels are reduced, the size of the socket-type charging equipment can be greatly reduced to achieve weight reduction and miniaturization. Furthermore, in addition to the above-mentioned level reduction to achieve the effect of reducing the size, the present disclosure also uses many miniaturized parts to replace the original components to achieve easy installation and product software update.

For example, the present disclosure uses a chip-type leakage detection circuit 98 to replace the current induction coil, it can shrink the current induction coil that occupies a large volume into a circuit formed by a circuit or a chip, thereby greatly reducing the volume occupied by the current induction coil. Moreover, since the shock resistance level of the socket-type charging equipment can be reduced, a smaller relay can be used in the present disclosure. Moreover, under the condition of using a smaller relay, the thickness of the copper sheet and the contact area in the relay are increased to reduce the generation of heat. In addition, since the thickness of the copper sheet and the contact area are increased, using the welding detection circuit 96 to confirm whether the contacts are welded can greatly reduce the situation where the power P is incorrectly transmitted. Moreover, since the waterproof level of the socket-type charging device 100 can be reduced, the corresponding waterproof structure design can be simplified, and therefore the overall volume of the present disclosure can be significantly reduced.

Due to the above-mentioned characteristics, the socket-type charging device 100 of the present disclosure can be reduced to a size that is substantially equivalent to that of a traditional socket box (for example, but not limited to, 120*70 mm, 118*74 mm, etc.) That is, the present disclosure can replace the socket usually placed in the socket box SB with the socket-type charging device 100 of the present disclosure, that is, the original location for general electrical appliances may be replaced with a location for the charging cable Lc. In contrast, the power density of the socket-type charging device 100 disclosed in the present disclosure may be increased to more than 300 W/in³. Therefore, without affecting the usability of the socket-type charging device 100 of the present disclosure, users can still use the current general charging connector for charging to increase the compatibility of the socket-type charging device 100. Moreover, since the socket-type charging device 100 has been shrunk to be accommodated in a traditional socket box, compared with the installation cost of more than 100,000 in the past, the socket-type charging device disclosed in the present disclosure can be used through the configuration of a traditional socket, thereby greatly reducing its installation cost.

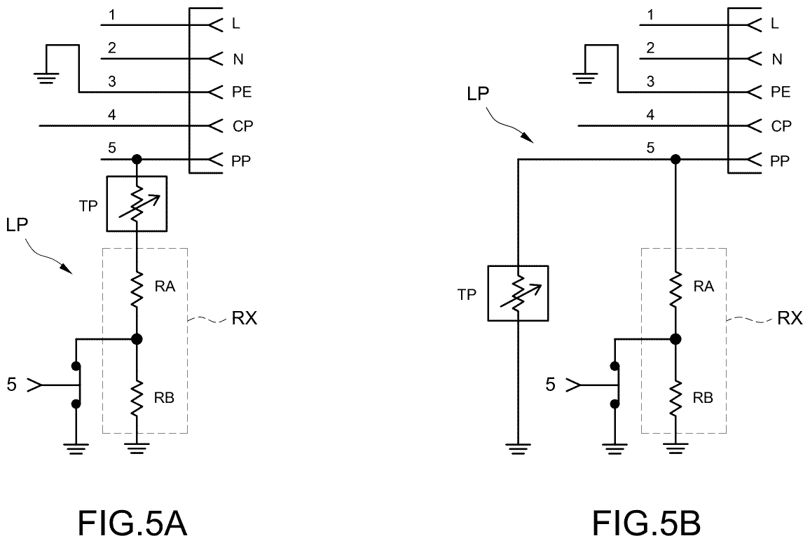

Please refer to FIG. 4 again, the socket-type charging device 100 further a proximity pilot circuit LP and a control pilot circuit LC. The controller 4 can also provide an indication signal Sn to the indicator lights 6-1 to 6-3 to control the indicator lights 6-1 to 6-3 to generate corresponding colored light. The proximity pilot circuit LP is coupled to the proximity pilot terminal PP and the ground wire PE, and the proximity pilot terminal PP is used to couple the electric vehicle Vh through the charging cable Lc, and confirms the connection completion between the electric vehicle Vh and the charging cable Lc. In particular, the path of the proximity pilot circuit LP may include a circuit composed of electronic components and wiring (as shown in the dotted box in the figure). Moreover, the circuit structure that can be implemented in the present disclosure may be seen in FIG. 5A and FIG. 5B described later. In order to avoid obscuring the characteristics of FIG. 4, the circuit structure within the dotted box will not be described in detail here. The control pilot circuit LC is coupled to a control pilot terminal CP and the controller 4, and the control pilot terminal CP is used to couple the electric vehicle Vh through the charging cable Lc. The controller 4 can transmit the pulse width modulation signal PWM to confirm the charging current with the electric vehicle Vh through a control pilot module CPM, and at the same time, the controller 4 can confirm the state of the electric vehicle Vh through the voltage level of the pulse width modulation signal PWM.

Please refer to FIG. 5A, which shows a block circuit diagram of a proximity pilot circuit according to a first embodiment of the present disclosure, and also refer to FIG. 2 to FIG. 4. The reset switch 5 is coupled to the proximity pilot circuit LP and the proximity pilot terminal PP. When the electric vehicle Vh is coupled to the charging cable Lc, the impedance of the proximity pilot terminal PP changes to a first specific impedance so that the electric vehicle Vh can confirm that the connection completion between the electric vehicle Vh and the charging cable Lc according to the first specific impedance. In some specific charging devices, in addition to coupling the electric vehicle Vh to the charging cable Lc, a press switch S3 needs to be pressed to briefly change the impedance of the proximity pilot terminal PP from the first specific impedance to the second specific impedance, and return to the first specific impedance to confirm the connection completion between the electric vehicle Vh and the charging cable Lc. In some other specific charging devices, the proximity pilot terminal PP is also coupled to the controller 4 so that the controller 4 can actively adjust the impedance of the proximity pilot terminal PP to in addition to confirming the connection completion between the electric vehicle Vh with the charging cable Lc, and also confirming additional parameters (such as but not limited to the operating mode, etc.). However, in order to avoid obscuring the characteristics of the present disclosure, only the most basic circuit structure is described in detail here.

Specifically, when the reset switch 5 is triggered by the trigger Tg, the reset switch 5 is turned off according to the trigger Tg so that the coupling relationship of the proximity pilot terminal PP to the ground wire PE is changed. Afterward, after the reset switch 5 is turned off, the reset switch 5 can return to the conduction state again according to the trigger Tg, or actively return to the conduction state. Therefore, when the reset switch 5 is triggered by a trigger Tg, the impedance between the proximity pilot terminal PP and the ground wire PE changes from the first specific impedance to the second specific impedance. Since the impedance between the proximity pilot terminal PP and the ground wire PE is changed to the second specific impedance, the electric vehicle Vh confirms that it is not connected to the charging cable Lc according to the second specific impedance so that the communication with the controller 4 is interrupted, thereby interrupting the charging or discharging operation of the power P. Moreover, after the operation is interrupted, the user may turn on the reset switch 5 by pressing the reset switch 5 again so that the impedance between the proximity pilot terminal PP and the ground wire PE is changed to the first specific impedance from the second specific impedance.

Alternatively, the reset switch 5 may be an active reset switch with a preset conduction state, and when the user presses the reset switch 5 and causes the reset switch 5 to be turned off according to the trigger Tg, the reset switch 5 can actively return to the conduction state after a short period of time. Therefore, the impedance between the proximity pilot terminal PP and the ground wire PE is changed to the second specific impedance from the first specific impedance, and to the first specific impedance again. Therefore, the connection completion between the electric vehicle Vh with the charging cable Lc is reconfirmed, and then the controller 4 can reconfirm the operating mode and resume mutual communication with the electric vehicle Vh.

In one embodiment, the coupling relationship of the proximity pilot terminal PP to the ground wire PE may be changed by turning on and turning off the reset switch 5 to change the impedance between the proximity pilot terminal PP and the ground wire PE. Moreover, as shown in FIG. 5A, the reset switch 5 may preferably be coupled to a voltage dividing circuit RX to implement the technical means of impedance change, but is not limited to the voltage dividing circuit. Therefore, any component or circuit connecting the proximity pilot terminal PP to the ground PE may be changed by turning on and turning off the reset switch 5 (for example, but not limited to, a rotary switch paired with a variable resistor, an optocoupler voltage divider, etc.), and all should be included in the scope of this embodiment. Taking the voltage dividing circuit RX including a first resistor RA and a second resistor RB as an example, the path between the proximity pilot terminal PP and the ground wire PE includes the first resistor RA and the second resistor RB connected in series, and the reset switch 5 is connected to the second resistor RB in parallel.

When the reset switch 5 is turned on, the proximity pilot terminal PP is coupled to the ground wire PE through the first resistor RA and the reset switch 5, and therefore the impedance of the proximity pilot terminal PP is the resistance of the first resistor RA. On the contrary, when the reset switch 5 is turned off, the proximity pilot terminal PP is coupled to the ground wire PE through the first resistor RA and the second resistor RB, and therefore the impedance of the proximity pilot terminal PP is the resistance of the first resistor RA plus the resistance of the second resistor RB. Therefore, when the reset switch 5 is turned off, the proximity pilot terminal PP provides the second specific resistance according to the first resistor RA and the second resistor RB. Accordingly, the connection state between the electric vehicle Vh and the charging cable Lc can be confirmed according to an impedance difference between the first specific impedance and the second specific impedance.

Please refer to FIG. 5A again, the proximity pilot circuit LP further includes a temperature protection device TP to avoid poor contact and excessive temperature rise. The temperature protection device TP is coupled to the proximity pilot terminal PP and the voltage dividing circuit RX in series. The temperature impedance of the temperature protection device TP is proportional to the ambient temperature around the proximity pilot terminal PP, and it is a positive temperature coefficient protection device (such as but not limited to a positive temperature coefficient protection resistor or a temperature protector that can automatically turn on or turn off). Taking the temperature protection device as the positive temperature coefficient protection resistor as an example, when the ambient temperature around the proximity pilot terminal PP is too high, the resistance of the temperature protection device TP (i.e., the positive temperature coefficient protection resistor) becomes larger (if it is too large, the voltage potential on the proximity pilot terminal PP may be regarded as floating) so that the controller 4 determines that the connection of the charging cable Lc is abnormal (that is, determines that a specific situation occurs), and therefore the transmission of the power P is interrupted. On the contrary, when the ambient temperature returns to the preset working range, the temperature protection device TP (i.e., the positive temperature coefficient protection resistor) returns to the normal resistance value so that the controller 4 can determine that the connection of the proximity pilot terminal PP is normal, and therefore the power P automatically resumes transmission.

Moreover, if the positive temperature coefficient protection device is a temperature protector that can automatically turn on or turn off, when the ambient temperature around the proximity pilot terminal PP is too high, the temperature protector is turned off and the voltage potential on the proximity pilot terminal PP may be regarded as floating so that the controller 4 determines that the connection of the charging cable Lc is abnormal (that is, determines that a specific situation occurs), and therefore the transmission of the power P is interrupted. On the contrary, when the ambient temperature returns to the preset working range, the temperature protector is turned on so that the controller 4 can determine that the connection of the proximity pilot terminal PP is normal, and therefore the power P automatically resumes transmission.

Please refer to FIG. 5B, which shows a block circuit diagram of a proximity pilot circuit according to a second embodiment of the present disclosure, and also refer to FIG. 2 to FIG. 5A. The proximity pilot circuit LP of FIG. 5B is similar to that of FIG. 5A, however, there is a discrepancy in the temperature protection device TP of FIG. 5B, which differs from that of FIG. 5A. Specifically, the temperature protection device TP of FIG. 5B is connected to the voltage dividing circuit RX in parallel. The temperature impedance of the temperature protection device TP is inversely proportional to the ambient temperature around the proximity pilot terminal PP, and it is a negative temperature coefficient protection device (such as but not limited to a negative temperature coefficient protection resistor or a temperature protector that can automatically turn on or turn off). Taking the temperature protection device as the negative temperature coefficient protection resistor as an example, when the ambient temperature around the proximity pilot terminal PP is too high, the resistance of the temperature protection device TP (i.e., the negative temperature coefficient protection resistor) becomes smaller (if it is too small, the voltage potential on the proximity pilot terminal PP may be regarded as directly coupling to the ground wire PE, i.e., approaching zero volt so that the controller 4 determines that the connection of the charging cable Lc is abnormal (that is, determines that a specific situation occurs), and therefore the transmission of the power P is interrupted. On the contrary, when the ambient temperature returns to the preset working range, the temperature protection device TP (i.e., the negative temperature coefficient protection resistor) returns to the normal resistance value so that the controller 4 can determine that the connection of the proximity pilot terminal PP is normal, and therefore the power P automatically resumes transmission. In one embodiment, if the negative temperature coefficient protection device is a temperature protector that can automatically turn on or turn off, and its on/off logic is similar to FIG. 5A, and its operating mode is similar to the temperature protector in FIG. 5A, which will not be described again here.

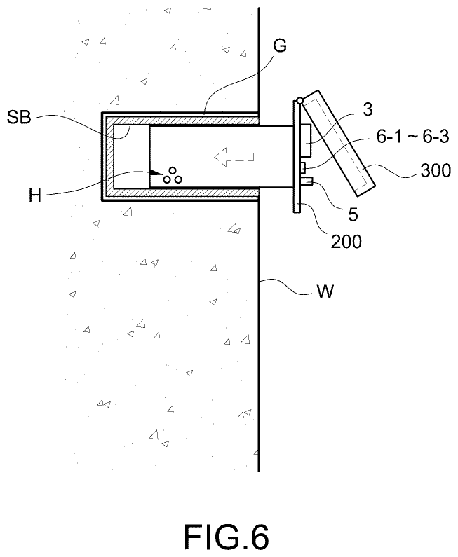

Please refer to FIG. 6, which shows a side view of the socket-type charging device according to a second embodiment of the present disclosure, and also refer to FIG. 2 to FIG. 5B. The difference between the socket-type charging device 100 shown in FIG. 6 and that shown in FIG. 2 is that the socket-type charging device 100 in FIG. 6 further includes a fixed frame 200 and a cover 300. The fixed frame 200 is used to fix the socket box SB, and the fixed frame 200 may be fixed to the housing 1 of the socket-type charging device 100 by, for example, but not limited to, engaging, locking, etc. Therefore, the fixed frame 200 may be used to fix the housing 1 of the socket-type charging device 100 to the socket box SB, and the fixed frame 200 may be engaged with the surface of the wall W so that one side 100-1 of the housing 1 is exposed to the wall W. Moreover, when the charging cable Lc is plugged into the socket-type charging device 100, the socket-type charging device 100 is fixedly connected to the socket box SB and will not be retracted inward into the socket box SB due to external force.

The cover 300 is pivotally engaged to the fixed frame 200 to axially rotate, and the cover 300 is used to cover the socket-type charging device 100 and exposed on the side 100-1 of the wall W. Preferably, the cover 300 is made of a light-permeable material for the colored light generated by the indicator lights 6-1 to 6-3 to penetrate. Therefore, the user does not need to lift the cover 300 and can confirm the operating state of the socket-type charging device 100 through the indicator lights 6-1 to 6-3. In addition, the cover 300 is used to protect the socket-type charging device 100 from dust and prevent rain and human accidental contact. Therefore, the socket-type charging device 100 of the present disclosure can achieve a protection level of IP44 or above and reduce the probability of maintenance. In one embodiment, the circuit, coupling relationship and operating mode not illustrated in FIG. 6 are similar to those in FIG. 2 and will not be described again here. In conclusion, as shown in FIG. 2 to FIG. 6 above, compared with the prior art in FIG. 1, the socket-type charging device 100 of the present disclosure does not suffer from problems such as accidentally falling, occupying space, being squeezed by foreign objects, being exposed to the sun, being overweight, being difficult to install, etc., thereby greatly increase convenience of use.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A socket-type charging device, disposed in an accommodation space of a socket box, and the socket box embedded in a wall, the socket-type charging device comprising:
a power port, coupled to a power wire through the socket box,
a connection port, disposed on a side of the socket-type charging device exposed to the wall, and the connection port configured to connect a charging cable of charging and discharging an electric vehicle, and
a controller, coupled to the power port and the connection port, and the controller configured to confirm an operating mode of charging and discharging the electric vehicle by the socket-type charging device.

2. The socket-type charging device as claimed in claim 1, further comprising:
a reset switch, disposed on the same side as the connection port, and the reset switch coupled to the controller,
wherein the controller is configured to determine an occurrence of a specific situation to enter a locked state, and the reset switch is configured to release the locked state according to a trigger so that the controller reconfirms the operating mode.

3. The socket-type charging device as claimed in claim 2, further comprising:
a power line, coupled to the power port and the charging cable, and the power line configured to transmit a power, and
an auxiliary power circuit, coupled to the power line, and configured to convert the power into a working power to supply power to the controller,
wherein the reset switch is coupled to the auxiliary power circuit and the controller, and the reset switch is configured to disconnect the working power according to the trigger so as to reactivate the controller to redetermine the operating mode.

4. The socket-type charging device as claimed in claim 3, further comprising:
a switch, disposed on the power line, and
a detection module, coupled to the power line and the controller, and the detection module configured to detect the power to generate a power parameter,
wherein the controller is configured to turn on or turn off the switch according to the power parameter.

5. The socket-type charging device as claimed in claim 4, where the detection module comprises:
a welding detection circuit, coupled to the power line and the controller, and the controller is configured to determine whether the switch can be correctly turned off according to a welding detection signal.

6. The socket-type charging device as claimed in claim 2, further comprising:
a proximity pilot terminal, coupled to the reset switch, and the proximity pilot terminal coupled to the electric vehicle through the charging cable so as to provide a first specific impedance for the electric vehicle to confirm that the connection with the charging cable is completed,
wherein the reset switch is configured to change the first specific impedance to a second specific impedance according to the trigger for the electric vehicle to reconfirm whether the connection with the charging cable is completed so that the controller redetermines the operating mode.

7. The socket-type charging device as claimed in claim 6, further comprising:
a voltage dividing circuit, coupled to the proximity pilot terminal, the voltage dividing circuit comprising a first resistor and a second resistor connecter in series,
wherein the reset switch is connected to the second resistor in parallel to provide the first specific impedance according to the first resistor when the reset switch is turned on, and provide the second specific impedance according to the first resistor and the second resistor when the reset switch is turned off.

8. The socket-type charging device as claimed in claim 7, further comprising:
a temperature protection device, coupled to the proximity pilot terminal and the voltage dividing circuit in series, and a temperature impedance of the temperature protection device is proportional to an ambient temperature, and the controller is configured to determine that the occurrence of the specific situation according to the temperature impedance is too high.

9. The socket-type charging device as claimed in claim 8, wherein the temperature protection device is a positive temperature coefficient protection resistor or a temperature protector.

10. The socket-type charging device as claimed in claim 7, further comprising:
a temperature protection device, connected to the voltage dividing circuit in parallel, and a temperature impedance of the temperature protection device is inversely proportional to an ambient temperature, and the controller is configured to determine that the occurrence of the specific situation according to the temperature impedance is too low.

11. The socket-type charging device as claimed in claim 10, wherein the temperature protection device is a negative temperature coefficient protection resistor or a temperature protector.

12. The socket-type charging device as claimed in claim 2, further comprising:
an indicator light, coupled to the controller, and the indicator light configured to generate corresponding colored light according to the operating mode,
wherein the connection port, the reset switch, and the indicator light are disposed in the socket-type charging device and exposed on a side of the wall.

13. The socket-type charging device as claimed in claim 12, further comprising:
a fixed frame, configured to fix a housing of the socket-type charging device to the socket box, and
a cover, pivotally engaged to the fixed frame to axially rotate, and the cover configured to cover the socket-type charging device and exposed on a side of the wall.

14. The socket-type charging device as claimed in claim 13, wherein the cover is made of a light-permeable material for the colored light generated by the indicator light to penetrate.

15. The socket-type charging device as claimed in claim 2, wherein the reset switch is an active reset switch with a preset conduction state, and the reset switch is configured to automatically return to the preset conduction state after being turned off according to the trigger.
